(19) United States
(12) Patent Application Publication
(10) Pub. No.: US 2014/0165667 A1
(43) Pub. Date: Jun. 19, 2014

(54) PICK-PROOF DOOR AND METHOD FOR PROTECTING DOOR SAFETY

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/093,060

(22) Filed: Nov. 29, 2013

(30) Foreign Application Priority Data
Dec. 13, 2012 (TW) 101147292

(51) Int. Cl. E05B 17/00

(52) U.S. Cl. CPC E05B 17/00
USPC 70/1.5

(57) ABSTRACT

In a method for protecting safety of a door. The method obtains a current image captured by an image capturing device installed in a key holder of a lock of the door, detects an object in the current image, and compares the current image with a preset key template when the object has been detected in the current image. The method further activates a safety guard unit of the door using a driving unit of the door when the current image does not match the key template, and locks a slip bolt of the safety guard unit.

### BACKGROUND

1. Technical Field

Embodiments of the present disclosure relate to safety monitoring technology, and particularly to a pick-proof door and a method for protecting door safety.

2. Description of Related Art

Pin tumbler locks are widely installed in a door to protect safety of the door. However, the pin tumbler locks can be easily damaged by a special lock-picker. For example, the special lock-picker is used for picking the door by pushing a plurality of pins (e.g., driver pins and key pins) in the pin tumbler lock upward, thus, a connection part between the driver pins and the key pins is moved to a plane of a shear point between a shell of the pin tumbler lock and a plug of the pin tumbler lock, and the pin tumbler lock is then unlocked by rotating the plug of the pin tumbler lock. Therefore, an new kind of lock which can better protect door safety is desired.

### BRIEF DESCRIPTION OF THE DRAWINGS

FIG. 1 is a block diagram of one embodiment of a door including a door safety protecting system.

FIG. 2 is a block diagram of function modules of the door safety protecting system included in the door.

FIG. 3 is a flowchart of one embodiment of a method for protecting door safety.

FIG. 4 is a schematic diagram of a lock installed with an image capturing device.

FIG. 5 is a schematic diagram of an example of creating a key template.

FIG. 6 is a schematic diagram of an example of determining whether an object is inserted into a key holder of the lock.

FIG. 7 is a schematic diagram of an example of comparing a current image captured by the image capturing device with the key template.

FIG. 8 is a schematic diagram of an example of a safety guard unit of the door in an activated state and an un-activated state.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

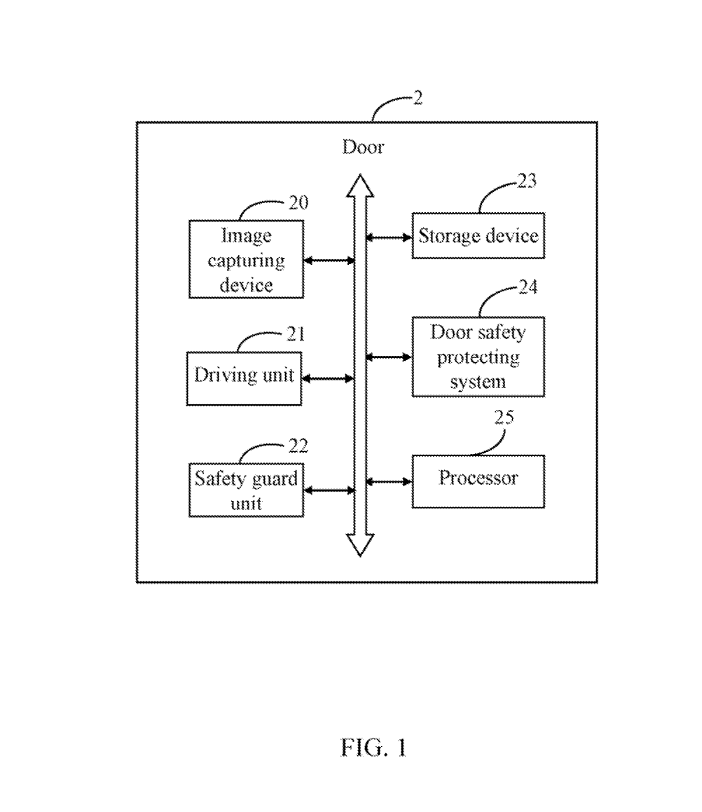

FIG. 1 is a block diagram of one embodiment of a door 2 including a door safety protecting system 24. The door 2 further includes an image capturing device 20, a driving unit (e.g., a driving motor) 21, a safety guard unit 22, a storage device 23, and at least one processor 25. FIG. 1 illustrates only one example of the door 2 that may include more or fewer components than illustrated, or a different configuration of the various components in other embodiments.

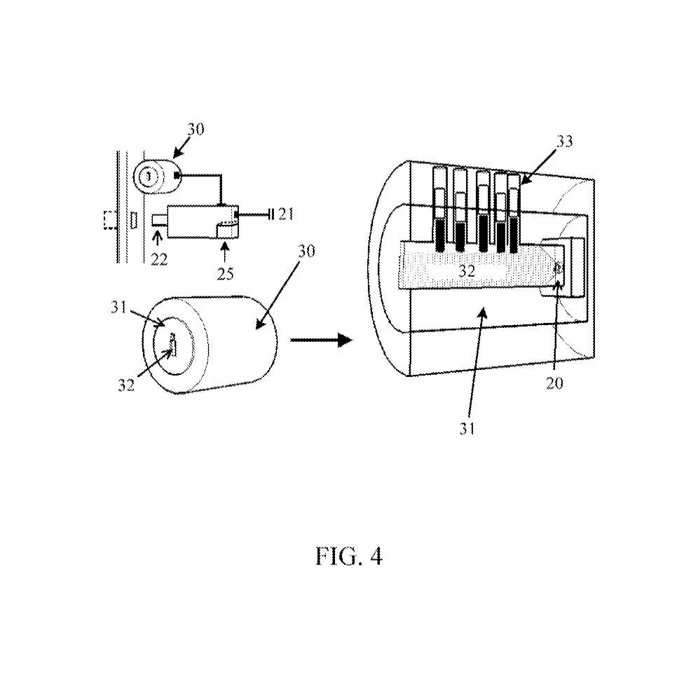

For example, as shown in FIG. 4, the door 2 further includes a lock 30. The lock 30 may be a pin tumbler lock or other suitable lockers. In one embodiment, the lock 30 includes a plug 31, a key holder 32, and a plurality of pins 33. The pins 33 include a plurality of driver pins and key pins.

In one embodiment, the image capturing device 20 may be positioned in the key holder 32 of the lock 30. The image capturing device 20 may be a depth-sensing camera, such as a time-of-flight (TOF) camera. In this embodiment, the image capturing device 20 is a camera system that captures a distance from a target object in an image captured by a lens of the image capturing device 20 (distance information) using the TOF principle. The image capturing device 20 can obtain a distance between the lens and each point on the target object that has been captured. Thus, each image captured by the image capturing device 20 includes distance information between the lens and each point on the target object in the image.

In one embodiment, the image capturing device 20 captures a digital image (hereinafter referred to as “image”) of an object when the object is inserted into the key holder 32 of the lock 30 of the door 2, and stores the captured image in the storage device 23. The door safety protecting system 24 detects an un-identified object in the captured image, and activates the safety guard unit 22 of the door 2 upon the condition that the un-identified object has been detected, to prevent illegally unlocking of the door 2.

In one embodiment, the storage device 23 stores images captured by the image capturing device 20 and an image template of an unlocking key of the lock 30 (hereinafter referred to as “key template”). The images in this embodiment are three dimensional (3D) images which are captured by the image capturing device 20. Depending on the embodiment, the storage device 23 may be a smart media card, a secure digital card, a compact flash card, or any other memory storage device.

In one embodiment, the door safety protecting system 24 may include computerized instructions in the form of one or more programs that are executed by the at least one processor 25 and stored in the storage device 23 (or memory). A detailed description of the door safety protecting system 24 will be given in the following paragraphs.

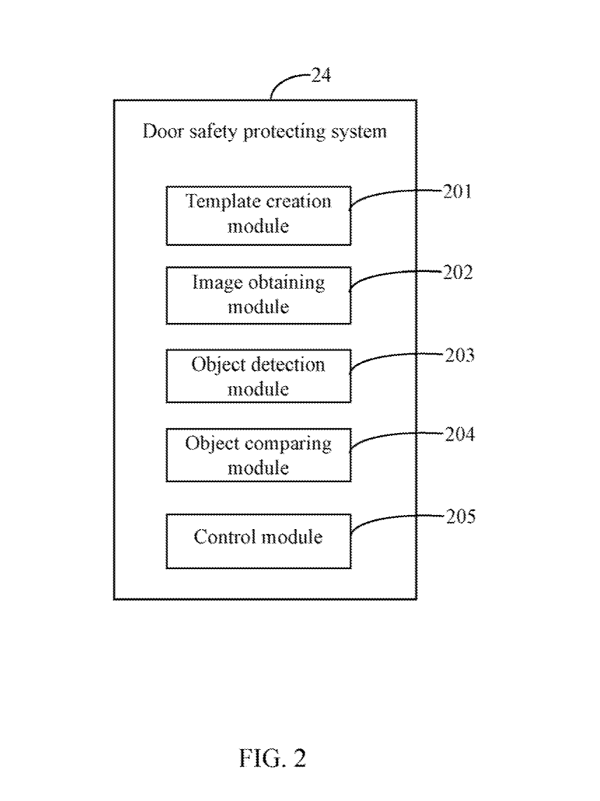

FIG. 2 is a block diagram of function modules of the door safety protecting system 24 included in the door 2. In one embodiment, the door safety protecting system 24 may include one or more modules, for example, a template creation module 201, an image obtaining module 202, an object detection module 203, an object comparing module 204, and a control module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

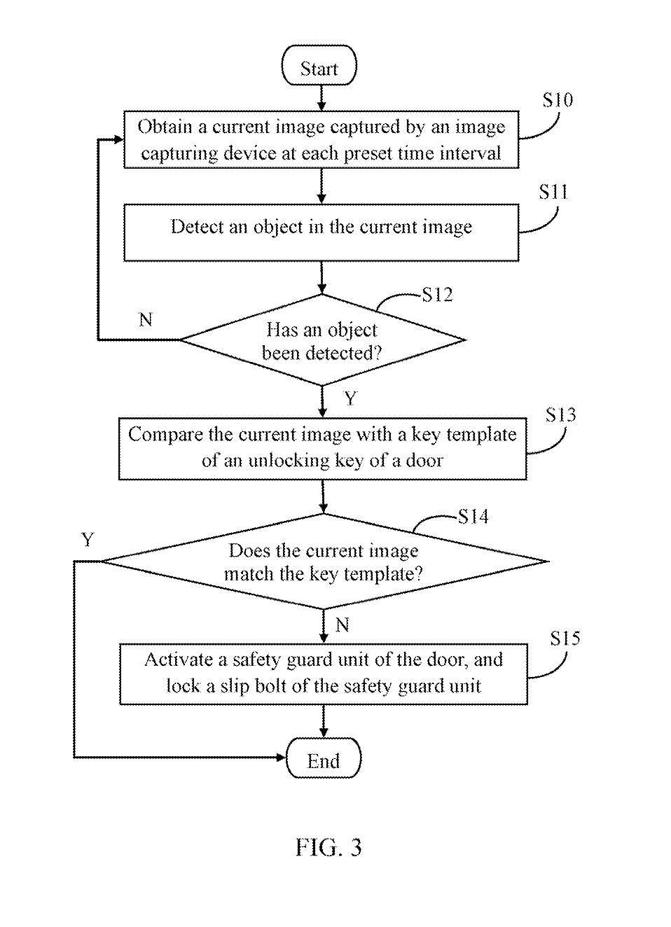

FIG. 3 is a flowchart of one embodiment of a method for protecting the safety of the door 2. Depending on the embodiment, additional steps may be added, others removed, and the ordering of the steps may be changed.

Before implementing the flow shown in FIG. 3, the template creation module 201 creates an image template 40 of an unlocking key corresponding to the lock 30 (hereinafter referred to as “key template 40”) according to the image of the unlocking key captured by the image capturing device 20, and stores the key template 40 in the storage device 23. A detailed description is as follows.

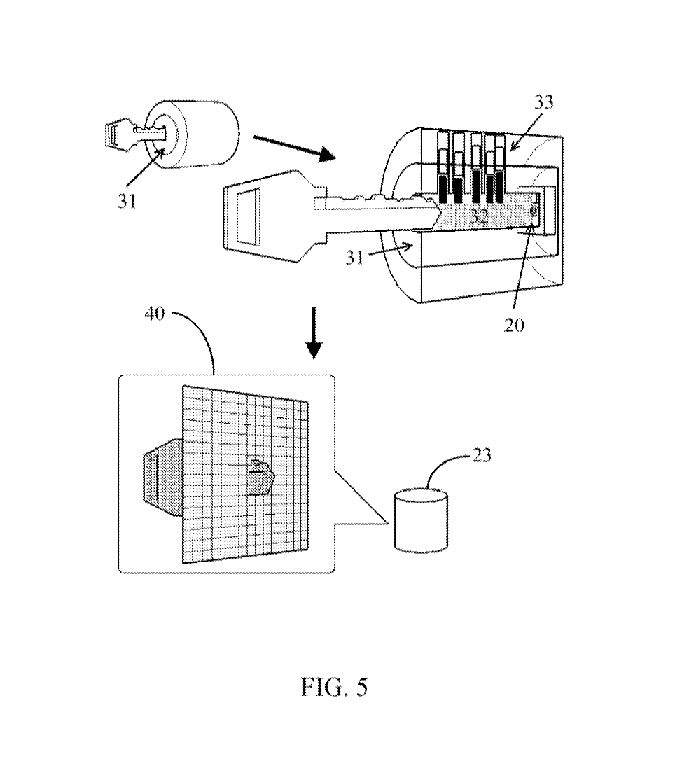

As shown in FIG. 5, when the unlocking key corresponding to the lock 30 is inserted into the key holder 32, the image capturing device 20 installed in the key holder 32 captures an image of the unlocking key (i.e., an image of a front part of the unlocking key), the image of the unlocking key is determined to be the key template 40 and is stored in the storage device 23.

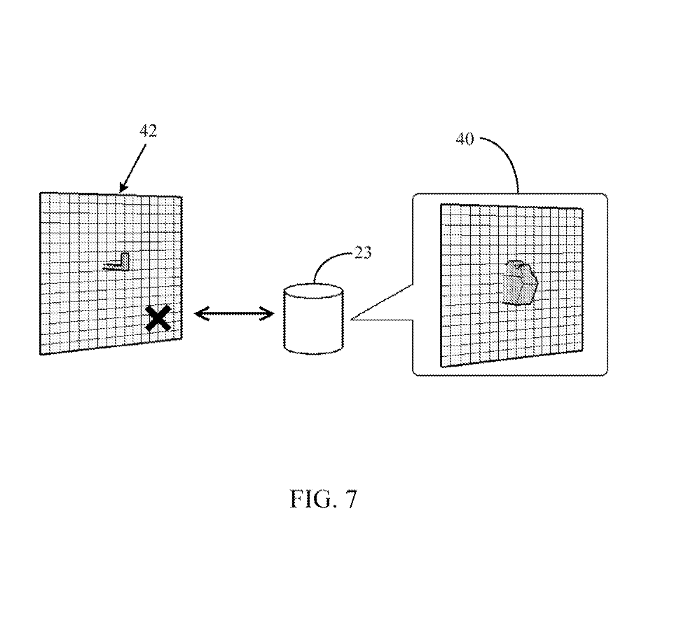

In block S10, the image obtaining module 202 obtains a current image 42 captured by the image capturing device 20 installed in the key holder 32 of the door 2 at each preset time interval (e.g., one second). An example of the current image 42 is shown in FIG. 7.

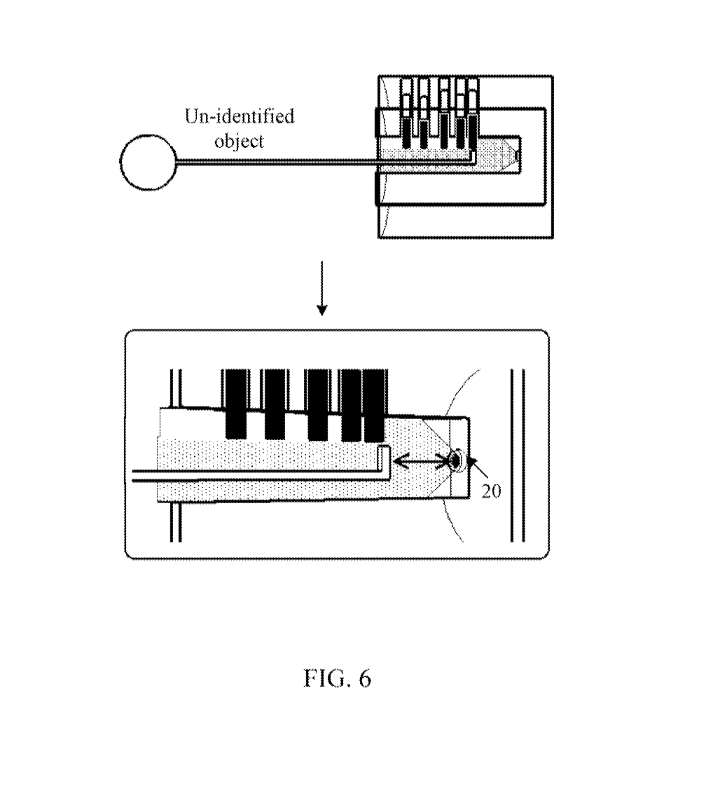

In block S11, the object detection module 203 detects an object (e.g., a lock-picker) in the current image 42. If a distance between the current image 42 and the lens of the image capturing device 20 is less than a distance between a previous image and the lens of the image capturing device 20, the object detection module 203 determines that an object is detected in the current image 42, that is, an object is inserted into the key holder 32 (refers to FIG. 6). The previous image is captured before the current image 42. The distance between the current image 42 and the lens of the image capturing device 20 is determined to be a distance between a feature point (e.g., a center point) of the current image 42 and the lens of the image capturing device 20. The distance between the previous image and the lens of the image capturing device 20 is determined to be a distance between a feature point (e.g., a center point) of the previous image and the lens of the image capturing device 20.

In step S12, the object detection module 203 determines whether an object has been detected in the current image 42. If the object has been detected in the current image 42, the procedure goes to step S13. If the object has not been detected in the current image 42, the procedure returns to step S10.

In step S13, the object comparing module 204 compares the current image 42 with the key template 40.

In step S14, the object comparing module 204 determines whether the current image 42 matches the key template 40. In one embodiment, the object comparing module 204 calculates a similarity between the current image 42 and the key template 40, and determines that the current image 42 matches the key template 40 when the similarity is greater than a preset proportion (e.g., 90%), that is, the object inserted in the key holder 32 is a matched key corresponding to the lock 30 (i.e., an identified object), then the procedure ends. If the similarity is less than or equal to the preset proportion, the object comparing module 204 determines that the current image 42 does not match the key template 40, that is, the object inserted in the key holder 32 is not the matched key corresponding to the lock 30 (i.e., an un-identified object, such as a lock-picker), then the procedure goes to step S15.

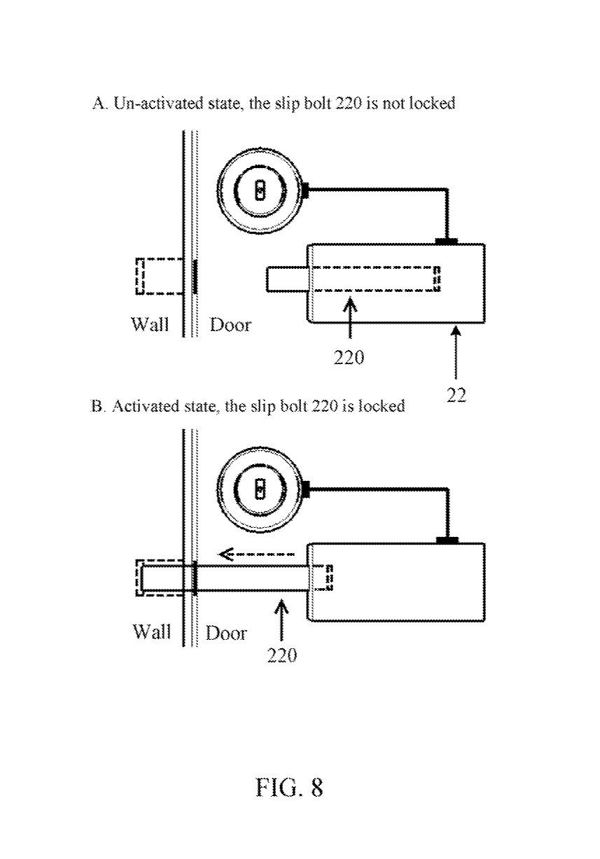

In step S15, the control module 205 activates the safety guard unit 22 of the door 2 using the driving unit 21 of the door 2, and locks a slip bolt 220 of the safety guard unit 22, so that the lock 30 of the door 2 is prevented from being illegally unlocked by the un-indentified object (e.g., a lock-picker). As shown in FIG. 8, state “A” represents an un-activated state (un-alarm state) that the slip bolt 220 of the safety guard unit 22 is not locked when the detected object in the current image 42 is the matched key of the lock 30 (identified object), and state “B” represents an activated state (alarm state) that the slip bolt 220 of the safety guard unit 22 is locked when the detected object in the current image 42 is not the matched key of the lock 30 (the un-identified object).

In one embodiment, the slip bolt 220 of the safety guard unit 22 is locked when an un-indentified object is inserted into the key holder 32 of the lock 30. In addition, when the matched key of the lock 30 is inserted into the key holder 32 of the lock 30, the control module 205 unlocks the slip bolt 220 of the safety guard unit 22 by moving the slip bolt 220 to an original position in the un-activated state, so that the user can open the door 2 by rotating the matched key of the lock 30.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for protecting safety of a door, the method comprising:
obtaining a current image captured by an image capturing device installed in a key holder of a lock of the door;
detecting an object in the current image, the current image comprising distance information between a lens of the image capturing device and each point of the object in the current image;
comparing the current image with a preset key template when the object has been detected in the current image; and
activating a safety guard unit of the door using a driving unit of the door when the current image does not match the key template, and locking a slip bolt of the safety guard unit.

2. The method according to claim 1, further comprising: creating the preset key template according to a captured image of a matched key corresponding to a key of the door, and storing the key template in a storage device of the door.

3. The method according to claim 1, further comprising: determining that an object is detected in the current image upon a condition that a distance between the current image and the lens of the image capturing device is less than a distance between a previous image and the lens of the image capturing device.

4. The method according to claim 3, wherein the distance between the current image and the lens of the image capturing device is determined to be a distance between a feature point of the current image and the lens of the image capturing device, and the distance between the previous image and the lens of the image capturing device is determined to be a distance between a feature point of the previous image and the lens of the image capturing device.

5. The method according to claim 1, further comprising: unlocking the slip bolt of the safety guard unit by moving the slip bolt to an original position in an un-activated state when a matched key of the lock is inserted into the key holder of the lock.

6. A door, comprising:
an image capturing device;
a driving unit;
a safety guard unit;
a processor;
a storage device storing a plurality of instructions, which when executed by the processor, causes the processor to:
obtain a current image captured by the image capturing device installed in a key holder of a lock of the door;
detect an object in the current image, the current image comprising distance information between a lens of the image capturing device and each point of the object in the current image;
compare the current image with a preset key template when the object has been detected in the current image; and
activate the safety guard unit using the driving unit when the current image does not match the key template, and lock a slip bolt of the safety guard unit.

7. The door according to claim 6, wherein the plurality of instructions further comprise: creating the preset key template according to a captured image of a matched key corresponding to a key of the door, and storing the key template in a storage device of the door.

8. The door according to claim 6, wherein the plurality of instructions further comprise: determining that an object is detected in the current image upon a condition that a distance between the current image and the lens of the image capturing device is less than a distance between a previous image and the lens of the image capturing device.

9. The door according to claim 6, wherein the distance between the current image and the lens of the image capturing device is determined to be a distance between a feature point of the current image and the lens of the image capturing device, and the distance between the previous image and the lens of the image capturing device is determined to be a distance between a feature point of the previous image and the lens of the image capturing device.

10. The door according to claim 6, wherein the plurality of instructions further comprise: unlocking the slip bolt of the safety guard unit by moving the slip bolt to an original position in an un-activated state when a matched key of the lock is inserted into the key holder of the lock.

11. A non-transitory storage medium having stored thereon instructions that, when executed by a processor of a door, causes the door to perform a method for protecting safety of the door, the method comprising:
obtaining a current image captured by an image capturing device installed in a key holder of a lock of the door;
detecting an object in the current image, the current image comprising distance information between a lens of the image capturing device and each point of the object in the current image;
comparing the current image with a preset key template when the object has been detected in the current image; and
activating a safety guard unit of the door using a driving unit of the door when the current image does not match the key template, and locking a slip bolt of the safety guard unit.

12. The non-transitory storage medium according to claim 11, wherein the method further comprises: creating the preset key template according to a captured image of a matched key corresponding to a key of the door, and storing the key template in a storage device of the door.

13. The non-transitory storage medium according to claim 11, wherein the method further comprises: determining that an object is detected in the current image upon a condition that a distance between the current image and the lens of the image capturing device is less than a distance between a previous image and the lens of the image capturing device.

14. The non-transitory storage medium according to claim 13, wherein the distance between the current image and the lens of the image capturing device is determined to be a distance between a feature point of the current image and the lens of the image capturing device, and the distance between the previous image and the lens of the image capturing device is determined to be a distance between a feature point of the previous image and the lens of the image capturing device.

15. The non-transitory storage medium according to claim 11, wherein the method further comprises: unlocking the slip bolt of the safety guard unit by moving the slip bolt to an original position in an un-activated state when a matched key of the lock is inserted into the key holder of the lock.
